(19) United States
(12) Patent Application Publication
(10) Pub. No.: US 2021/0406158 A1
(43) Pub. Date: Dec. 30, 2021

(54) SYSTEMS AND METHODS FOR AUTOMATED DEVICE TESTING

(71) Applicant: T-Mobile USA, Inc., Bellevue, WA (US)

(72) Inventors: Jonathan Junghan Yu, Tacoma, WA (US); Jeffery Smith, Bothell, WA (US)

(21) Appl. No.: 16/910,737

(22) Filed: Jun. 24, 2020

(51) Int. Cl. G06F 11/36

(52) U.S. Cl. CPC G06F 11/3688; G06F 11/368; G06F 11/3692; G06F 11/3684

(57) ABSTRACT

Systems and methods present practical applications to software design and testing by providing a driver or platform that implements a simplified testing process to automate test scripting and to create multiple environments to run software and device tests. The driver or platform may be modular such that a user may add more testing scripts to an environment without re-building the environment for every test, The platform may also allow the user to make changes to each script and perform tests with specific options (e.g,, testing synchronously or asynchronously, defining the number of test executions, etc.). The platform may be configured to set up devices for each test and initiate specific drivers for each test. In some embodiments, the platform may set up each device involved in a test, start the related drivers, and create different threads for executing different aspects of the test.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Rigorous application testing drives software reliability and the user experience. Testing is typically the process of executing a program or application with the intent of identifying errors or “bugs” that cause the program to execute in an unexpected manner. The goal of testing is to validate that a piece of software meets its business and technical requirements and is the primary way to check that the product meets its requirements adequately.

The typical testing process can be labor intensive and require extensive coding to implement. For example, each test must be designed to consider what systems the software uses and specific configurations for those systems, non-functional requirements, key processes to follow, tools to use for logging defects and test case scripting, documentation, testing environment, risks and dependencies, entry/exit criteria, etc.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

The disclosure presents practical applications to software design and testing by providing a driver or platform that implements a simplified testing process to automate test scripting and create multiple environments to run software and device tests. The driver or platform may be modular such that a user may add more testing scripts to an environment without re-building the environment for every test. The platform may also allow the user to make changes to each script and perform tests with specific options (e.g., testing synchronously or asynchronously, defining the number of test executions, etc.). The platform may be configured to set up devices for each test and initiate specific drivers for each test. In some embodiments, the platform may set up each device involved in a test, start the related drivers, and create different threads for running the tests synchronously or asynchronously.

In further embodiments, a system or platform may test a test application for proper execution on a particularly-configured computing device. The platform may include a processor and a memory for storing processor-executable instructions. In some embodiments, the instructions may receive a plurality of application testing parameters from a developer computer system via a user interface of the ADT platform. The application testing parameters may each correspond to a particularly-configured computing device. Further instructions may, upon execution, load one or more resources corresponding to a configuration of the particularly-configured computing device. The one or more resources may permit execution of the test application on the ADT platform. In response to the plurality of application testing parameters from a developer computer system, the instructions may also automatically send a control signal to the ADT platform to execute each of the plurality of application testing parameters on a separate thread of the ADT platform for testing the test application according to the plurality of application testing parameters.

In still further embodiments, a computer-implemented method may also test a test application for proper execution on a particularly-configured computing device. For example, the method may receive the a plurality of application testing parameters from a developer computer system via a user interface of an ADT platform. The application testing parameters may each correspond to a particularly-configured computing device. The method may also load one or more resources corresponding to a configuration of the particularly-configured computing device. The one or more resources may permit execution of the test application on the ADT platform. In response to the plurality of application testing parameters from a developer computer system, the method may automatically send a control signal to the ADT platform to execute each of the plurality of application testing parameters on a separate thread of the ADT platform for testing the test application according to the plurality of application testing parameters.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is an illustration of an exemplary system for automating device testing in accordance with the current disclosure; and

FIG. 2 is an illustration of a flow chart for a method for automating device testing in accordance with the current disclosure.

### DETAILED DESCRIPTION

The present application describes embodiments including various elements that are present in a device testing environment such as control signals, modules, blocks, functions, data structures, etc. These elements are not an exhaustive collection of all elements needed to perform the functions of a testing environment (i.e., a platform or computer-executable method for automating test scripting and creating multiple environments to run software and device tests) or the disclosed embodiments. Indeed, the elements associated with the systems and methods described in this application are only some of the possible elements that are needed to implement the embodiments. Some embodiments may include more or fewer elements than those that are described with the embodiments, as known by a person having ordinary skill in the art of mobile telecommunications systems.

The disclosure presents practical applications to software design and testing by describing a system and method (e.g., a driver or platform and a computer-implemented method) that implements a simplified testing process to automate test scripting and create multiple environments to run software and device tests, The driver or platform may be modular such that a user may add more testing scripts to an environment without re-building the environment for every test. The platform may also allow the user to make changes to each script and perform tests with specific options (e.g., testing synchronously or asynchronously, defining the number of test executions, etc.). The platform may be configured to set up devices for each test and initiate specific drivers for each test. In some embodiments, the platform may set up each device involved in a test, start the related drivers, and create different threads for running the tests synchronously or asynchronously.

The present application describes a technical solution to the technical problem of implementing testing scripts for applications for proper execution on particular devices (e.g., Android®, iOS®, Windows®, Linux®, etc., devices). The present application solves this technical problem by implementing a driver or platform including a modular script package for automating application testing on these particular devices. The script package may include any number of different scripts that may be selected by the user through a user interface of the platform as options for testing the application. For example, the script package may include one or more scripts to customize the number of test runs, the execution of testing scripts either synchronously or asynchronously, test execution with debug mode enabled or disabled, etc,

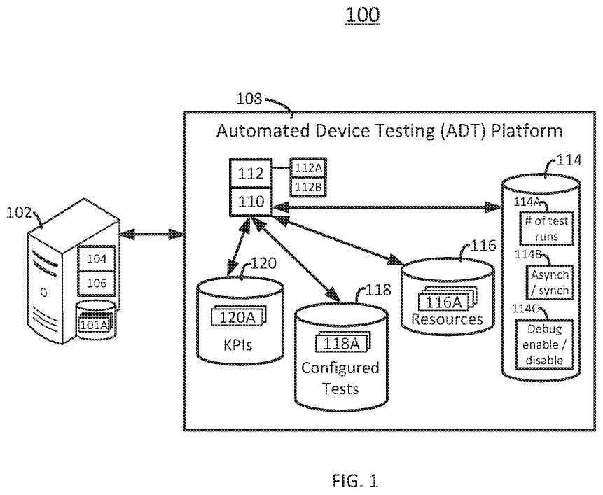

FIG. 1 generally illustrates one embodiment of an application programming interface (API) developer system 100 for developing and testing a test application 101A for proper execution on various particularly-configured devices without developing separate code/testing scripts for testing the applications 101A outside the system 100.

In some embodiments, the system 100 includes a developer computer system 102 having a processor 104 for executing processor-executable instructions of various modules that are stored in processor-readable memories of the system 100, such as memory 106. The developer computer system 102 may also include a test application repository 101 for storing the one or more test applications 101A, In some embodiments, the developer computer system 102 may be functionally connected via a computer network to an automated device testing (ADT) platform 108. In other embodiments, the developer computer system 102 may execute the ADT platform 108 itself. For example, in some embodiments, the developer computer system 102 may cause the processor 104 to execute instructions stored in its computer memory 106 to send a control signal to a remote ADT platform 108 to implement an instance of the ADT platform 108 and corresponding user interfaces of the ADT platform 108 (e.g., UI 112B) using the developer computer system 102. In other embodiments, the developer computer system 102 may cause the processor 104 to execute instructions stored in its computer memory 106 to send a control signal to a local ADT platform 108 to implement an instance of the ADT platform 108 and corresponding user interfaces of the ADT platform 108 on the developer computer system 102.

The ADT platform 108 may include a driver, an integrated development environment (IDE), software framework, or other set of processor-executable instructions for execution directly on the developer computer system 102 or remotely via a computer network that provides features to computer programmers for software development generally and application testing for different, particularly-configured computing devices and device environments in particular. The platform 108 may also include a processor 110 and a memory 112. The memory may store a testing module 112A and a user interface 112B including instructions for execution on one or more processors of the system 100. The testing module 112A may include instructions to parse plaint text instructions received at the ADT platform 108 from the developer computer system 102. Upon receiving and parsing the plain test instructions, the ADT platform may automatically determine the particularly-configured computing device for the test application 101A and/or to allow selecting the particularly-configured computing device via the user interface 112B.

Upon receiving or determining an indication of the configuration for the particularly-configured computing device (e.g., Android®, iOS®, Windows®, etc.), the instructions may cause the processor(s) to load one or more resources 116A that correspond to the configuration from a resources repository. These loaded resources 116A may permit execution of the test application 101A on the ADT platform 108. Without loading the resources corresponding to the device configuration, the test application 101A cannot execute or be tested according to the test scripts 114A, 114B, 114C using the ADT platform 108. The instructions may also cause the processor(s) to automatically send control signals to one or more other processors of the system 100 to execute various built-in test scripts 114A, 114B, 114C that are indicated in the plain text instructions and correspond to the device configuration (e.g., Android®, iOS®, Windows®, etc.) from a built-in test script repository 114 as the one or more application testing parameters. For example, the test scripts 114A, 114B, 114C may include a number of runs script 114A to test a test application 101A a selected number of times on a particular device environment. In further embodiments, a synchronous or asynchronous selection script 114B may allow a test application 101A to be tested while the device executes one instruction at a time (synchronously) or while executing multiple instructions at a time without waiting for other processes of the test application 101A to finish (asynchronously). A third configuration of the system 100 may include a debug mode enable/disable script 114C that permits the test application 101A to execute normally until it reaches a statement containing a breakpoint. At this point, the script 114C may send a control signal to stop execution of the application 101A to permit analysis of the application execution. The script 114C may then permit single-step execution of the test application 101A until execution reaches another breakpoint, or stopping the debugging run to change the application code.

The system 100 generally and the built-in script repository 114 in general may include scripts that are each configured to test specific application instructions on specific device types (e.g., Android®, iOS®, Windows®, etc.). For example, while FIG. 1 shows one set of built-in test scripts 114A, 114B, 114C, the system 100 may include multiple sets of test scripts where each set is configured for implementing the tests for a test application 101A on a different, particularly-configured device (i.e., one set of tests for Android® devices, another set for iOS® devices, for Windows® devices, etc.). Each test script 114A, 114B, 114C may include instructions for execution by the processor(s) 104, 110 for sending control signals to various elements of the platform 108 or other elements of the system 100 for loading one or more required device drivers or other resources 116A from a local or remote resources repository 116 and implementing a configured application test script 118A from a configured application test repository 118, and each test 118A includes one or more of the test scripts 114A, 114B, 114C for the particularly-configured device. For example, each configured application test script 118A may implement one or more of the various built-in test scripts 114A, 114B, 114C. In some embodiments, each built-in test script 114A, 114B, 114C may execute as a different thread when executing the test. Keeping each built-in test script on its own thread may facilitate modularity of the platform. The configured test scripts 118A and the individual test scripts 114A, 114B, 114C may be re-used or edited for a future test of the test application or to test a different test application 101A for operation on different particularly-configured devices. More test scripts may be added to the repository 114 or edited for different particularly-configured devices. Similarly, resources 116A may be added or edited as needed for future testing of test applications 101A that require different resources.

The automated device testing platform 108 may also include a Key Performance Indicator (KPI) repository 120 storing one or more Key Performance Indicators (KPIs) 118A for each test. Each KPI 120A may be a detailed specification that is measured and analyzed by the system 100 to ensure compliance of the test application 101A with the objectives of the business. KPIs may be metrics that are calculated by the system to ensure the test application 101A is moving in the right direction and is achieving the target effectively, which was defined during the planning, strategic, and/or budget design process. In some embodiments, the test module 112A may include further instructions to measure performance of the test application 101A against one or more of the KPIs 120A. Further instructions may also facilitate the software development process by allowing the system 100 to edit or modify the test application 101A and take any necessary design edits or other steps when the performance of the product does not meet the defined objectives of the KPIs 120A. For example, each KPI 120A may correspond to a threshold that, when exceeded, may cause the system 100 to execute instructions to modify the test application 101A or send a control signal to a user interface 112B to display an indication that a KPI threshold for the test application 101A has been exceeded.

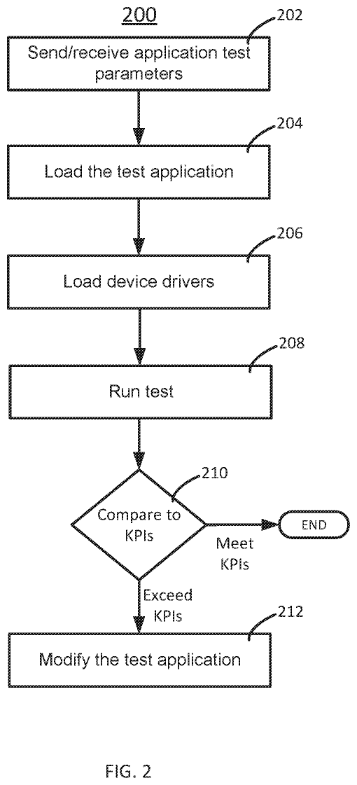

FIG. 2 is a flowchart of a computer-implemented method 200 for completing one or more processes for testing a test application 101A within the ADT platform 108. As described herein, test scripts 114A and device resources 116A may be stored within local or remote repositories and used for testing a test application 101A on the ADT platform 108. Each step of the method 200 is one or more computer-executable instructions (e.g., control signals, modules, blocks, stand-alone instructions, etc.) performed on a processor of a server or other computing device (e,g., base station, electronic device, other computer system illustrated in FIG. 1 and/or described herein) which may be physically configured to execute the different aspects of the method. Each step may include execution of any of the instructions as described in relation to the system 100 as part of the automated device testing systems and methods described herein or other component that is internal or external to the system 100. While the below blocks are presented as an ordered set, the various steps described may be executed in any particular order to complete the methods described herein.

At block 202, the computer-implemented method 200 may initiate an application testing process by causing a processor to send application test parameters to an automated device testing (ADT) platform 108. In some embodiments, a first processor of a developer computer system 102 may send a control signal via an instance of the user interface 112B to a second processor of the automated testing platform 108. In some embodiments, the instance of the user interface 112E may execute on the developer computer system 102. In other embodiments, the instance of the user interface 112B may execute remotely from the developer computer system 102. The control signal may include indications of the application test parameters corresponding to a test application 101A. For example, the control signal may include an indication of the test application 101A and a file location of its codebase or portions of its codebase that are to be tested by the platform 108, an indication of a device type corresponding to the test application (e.g., Android®, iOS®, Windows®, etc.), a number of runs of the test application to complete the test, whether the test is to be executed synchronously or asynchronously, whether debug mode is enabled or disabled for the test runs, etc. In still further embodiments, the developer computer system 102 may send plain text commands to the platform 108 and the method 200 may parse the plain test and link together the built-in test scripts indicated in the plain text for one, coherent test of the test application 101A,

At block 204, the method may load the test application 101A or other code that was indicated by the control signal into the memory 110 of the platform 108. In some embodiments, the developer computer system 102 may send the test application 101A to the platform 108 in response to the control signal. In other embodiments, the method 200 may send a file location for the test application that the platform 108 may then use to retrieve the test application 101A from the test application repository 101.

At block 206, the method 200 may load one or more drivers for the device type in response to the control signal. For example, if the control signal indicates an Android® device type, then a processor 110 of the platform 108 may load one or more drivers or other device-specific resources 116A for Android® devices from the resources repository 116. Likewise, if the control signal indicates an iOS® device type, then the processor 110 of the platform 108 may load one or more drivers or other device-specific resources 116A for iOS® devices from the resources repository 116. In some embodiments, and in response to loading the test application 101A, the platform 108 may analyze the test application 101A to determine which resources 116A are needed from the repository 116 for proper execution of the test as indicated in the control signal of block 202. In other embodiments, the control signal of block 202 may indicate what resources 116A are needed from the repository 116 and the built-in script repository 114, and, in response, load them into the platform memory 112. In still other embodiments, the method 200 may automatically load one or more of the resources 116A and the built-in test scripts 114A, 114B, 114C for the test into the platform memory 112 based on the selections indicated in the control signal of block 202. For example, in response to the control signal indicating an Android® device type and synchronous execution, the method may load Android® device drivers from the resource repository 116 as well as a synchronous selection script 114B for Android® devices into the platform memory 112.

At block 208, once the method 200 gathers resources 116A and built-in test scripts (e.g., 114A, 114B, 114C) indicated or determined from the control signal of block 202, the method may store the gathered resources 116A and built-in test scripts (e.g., 114A, 114B, 114C) as a configured application test script 118A and run the test. As described herein, the method 200 may start a thread for each built-in test script indicated by the test and each configured application test script 118A may implement one or more of the various built-in test scripts 114A, 114B, 114C. In some embodiments, block 208 may include creating different execution threads for running the test script synchronously or asynchronously. The configured test scripts 118A and the individual test scripts 114A, 114B, 1140 may be re-used or edited for use to test a different test application 101A for operation on different particularly-configured devices. Execution of the configured application test script 118A may also provide statistics or other results that are related to one or more KPIs 120A for each test. Measuring these KPIs during test execution may ensure compliance of the application with the objectives of the business.

At block 210, the method 200 may compare one or more of the KPIs 120A against the performance of the test application 101A during the test. If the KPIs 120A for the test 118A are not met or fall below a desired threshold, then the method 200 may proceed to block 212 where the method may modify the test application 101A for re-execution. If the KPIs 120A for the test are met or exceed a desired threshold, then the method 200 may end.

Thus, the system 100 and method 200 described herein are directed to a modular testing platform that may facilitate testing script design for applications that execute on particularly-configured devices. The ADT platform 108 is kept separate from the built-in test scripts 114A, 114B, 114C by running each built in test script on a different thread according to plain text instructions or test configurations passed to the platform 108 from the developer computer system 102 via the user interface 112B. The simplified testing system and process may automate test scripting and create multiple environments to run software and device tests while keeping the platform 108 separate from the test scripts by multi-threading test execution. The driver or platform may be modular such that a user may add more testing scripts to an environment without re-building the environment for every test. The platform may also allow the user to make changes to each script and perform tests with specific options (e.g., testing synchronously or asynchronously, defining the number of test executions, etc.). The platform may be configured to set up devices for each test and initiate specific drivers for each test. In some embodiments, the platform may set up each device involved in a test, start the related drivers, and create different threads for running the tests synchronously or asynchronously.

Additionally, certain embodiments are described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g,, as a special-purpose processor, such as a field programmable gate array (FPGA) or an application-specific integrated circuit (ASIC)) to perform certain operations. A hardware module may also comprise programmable logic or circuitry (e,g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a processor configured using software, the processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled via control signals. Where multiple of such hardware modules exist contemporaneously, communications may be achieved through a signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within an environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within an environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other, The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. An automated device testing (ADT) system for testing a test application for proper execution on a particularly-configured computing device, the platform including a processor and a memory for storing processor-executable instructions to:
receive a plurality of application testing parameters from a developer computer system via a user interface of the ADT platform, wherein the application testing parameters each correspond to a particularly-configured computing device; and
load one or more resources corresponding to a configuration of the particularly-configured computing device, wherein the one or more resources permit execution of the test application on the ADT platform;
wherein, in response to the plurality of application testing parameters from a developer computer system, automatically sending a control signal to the ADT platform to execute each of the plurality of application testing parameters on a separate thread of the ADT platform for testing the test application according to the plurality of application testing parameters.

2. The system of claim 1, wherein the plurality of application testing parameters include one or more built-in test scripts.

3. The system of claim 2, wherein the one or more test scripts include a number of runs script for testing the test application a selected number of times, a synchronous or asynchronous selection script for allowing the test application to be selectively tested while the ADT platform executes instructions of the test application synchronously or while executing multiple instructions of the test application asynchronously, and a debug mode enable/disable script for executing the test application until the test application reaches a statement containing a breakpoint.

4. The system of claim 3, including further processor-executable instructions to store a further plurality of application testing parameters for a future test of the test application.

5. The system of claim 3, including further processor-executable instructions to measure a key performance indicator (KPI) while testing the test application for determining proper execution of the test application on the particularly-configured computing device.

6. The system of claim 5, including further processor-executable instructions to compare the measured KPI against a stored KPI.

7. The system of claim 6, including further processor-executable instructions to modify the test application when the measured KPI exceeds a threshold of the stored KPI.

8. The system of claim 1, wherein the developer computer system is remote from the ADT platform.

9. The system of claim 1, wherein the instructions to receive the plurality of application testing parameters from the developer computer system via the user interface of the ADT platform further includes instructions to receive the plurality of application testing parameters as a plain text message at the ADT platform.

10. The system of claim 9, including further including instructions to:
parse the plain text message; and
determine the configuration of the particularly-configured computing device based on the parsed plain text message.

11. A computer-implemented method for testing a test application for proper execution on a particularly-configured computing device, the method comprising:
receiving a plurality of application testing parameters from a developer computer system via a user interface of an ADT platform, wherein the application testing parameters each correspond to a particularly-configured computing device;
loading one or more resources corresponding to a configuration of the particularly-configured computing device, wherein the one or more resources permit execution of the test application on the ADT platform; and
in response to the plurality of application testing parameters from a developer computer system, automatically sending a control signal to the ADT platform to execute each of the plurality of application testing parameters on a separate thread of the ADT platform for testing the test application according to the plurality of application testing parameters.

12. The computer-implemented method of claim 11, wherein the one or more application testing parameters include one or more built-in test scripts.

13. The computer-implemented method of claim 12, wherein the one or more test scripts include a number of runs script for testing the test application a selected number of times, a synchronous or asynchronous selection script for allowing the test application to be selectively tested while the ADT platform executes instructions of he test application synchronously or while executing multiple instructions of the test application asynchronously, and a debug mode enable/disable script for executing the test application until the test application reaches a statement containing a breakpoint.

14. The computer-implemented method of claim 13, further comprising storing a further plurality of application testing parameters for a future test of the test application.

15. The computer-implemented method of claim 13, further comprising measuring a key performance indicator (KPI) while testing the test application for determining proper execution of the test application on the particularly-configured computing device.

16. The computer-implemented method of claim 15, further comprising comparing the measured KPI against a stored KPI.

17. The computer-implemented method of claim 16, further comprising modifying the test application when the measured KPI exceeds a threshold of the stored KPI.

18. The computer-implemented method of claim 11, wherein the developer computer system is remote from the ADT platform.

19. The computer-implemented method of claim 11, wherein receiving the plurality of application testing parameters from the developer computer system via the user interface of the ADT platform further comprises receiving the plurality of application testing parameters as a plain text message at the ADT platform.

20. The computer-implemented method of claim 19, further comprising:
parsing the plain text message; and
determining the configuration of the particularly-configured computing device based on the parsed plain text message.
